(19) United States
(12) Patent Application Publication
(10) Pub. No.: US 2023/0375970 A1
(43) Pub. Date: Nov. 23, 2023

(54) IMAGE FORMING APPARATUS

(71) Applicant: CANON KABUSHIKI KAISHA, Tokyo (JP)

(72) Inventors: TSUYOSHI TAJIRI, Tokyo (JP); TOMOYA INUZUKA, Chiba (JP); TOMOTAKA UEKI, Ibaraki (JP); KAZUYUKI NARITA, Chiba (JP)

(21) Appl. No.: 18/316,447

(22) Filed: May 12, 2023

(30) Foreign Application Priority Data
May 20, 2022 (JP) 2022-083124

(51) Int. Cl. G03G 15/00; G03G 15/01

(52) U.S. Cl. CPC G03G 15/5062; G03G 15/01

(57) ABSTRACT

An image forming apparatus includes: an image bearing member configured to rotate; an image forming unit configured to form an image on the image bearing member; a detection unit configured to detect a test image formed on the image bearing member by the image forming unit; a controller configured to control a magnification of an image to be formed by the image forming unit based on a detection result of the test image by the detection unit.

### FIELD OF THE INVENTION

### Background of the Invention

The present disclosure relates to an image forming apparatus, such as a printer, a copying machine, or a multifunction apparatus.

### Description of the Related Art

There are image forming apparatuses which form a color image by superimposing toner images, which are formed in different color and different from each other, onto an intermediate transfer member to transfer the same. In these image forming apparatuses, image quality deteriorates in a case where positions of the toner images of each color on the intermediate transfer member are misaligned and overlapped. To prevent the deterioration of the image quality, these image forming apparatuses have a configuration in which deviation amounts of the positions of the toner images of each color are corrected to form an image. In this configuration, a test image formed on the intermediate transfer member is read by a sensor, and a deviation amount from an ideal position of the test image is detected based on a reading result to correct the deviation amount.

For example, an optical sensor is used for a sensor for reading the test image. The optical sensor irradiates light onto the intermediate transfer member to detect an amount of reflected light. The intermediate transfer member rotates to convey the test image such that the test image passes through a detection position (irradiation position of light) of the sensor. As to a light spot (irradiation spot diameter) formed by irradiating light from the sensor, the size of the same should be more than a predetermined size that enables obtaining a sufficient light amount to stabilize detection performance. Moreover, to stably distinguish the difference between an amount of reflected light from the test image formed on the intermediate transfer member and an amount of reflected light from a surface of the intermediate transfer member, the test image is formed such that it is more than the irradiation spot diameter in a conveyance direction of the test image by the intermediate transfer member (U.S. Pat. No. 9,047,550 B2).

The test image for correcting an image forming position is a pattern image of two or more rectangles, for example. A position of each pattern image is detected based on a detection result of an optical sensor. Correction of the writing position of an image is performed based on the detected position. A size of the pattern image and a distance between the pattern images are restricted by the irradiation spot diameter of the optical sensor. That is, the size of the pattern image is set more than the irradiation spot diameter. Also, the distance between the pattern images is set more than the irradiation spot diameter.

The deviations of the image on the intermediate transfer member in the conveyance direction include steady deviation in which the entire area where images can be formed deviates a predetermined amount, and deviation in which the deviation amount changes periodically. Change of the periodic deviation amount occurs in one cycle of a rotation member such as a photosensitive member and various rollers which support the intermediate transfer member. For example, the image is always formed at a fixed interval onto a surface of a rotating photosensitive member. However, the formed image will expand and contract in a rotation direction (conveyance direction) due to a shape or uneven rotation speed of the photosensitive member. This means that the deviation from an ideal image position occurs periodically. In order to suppress the periodic position deviation of the image, the following methods are performed.

For each position in the conveyance direction, the position deviation amount is acquired by repeatedly forming rectangular pattern images on the intermediate transfer member and detecting the position of the pattern images using an optical sensor. This position deviation amount includes an amount of change similar to a sine function with a position of the formed image in the conveyance direction as a variable. The position deviation amount is converted into an approximate expression of a sine function, and is expressed using two constants, i.e., a wavelength and an amplitude.

However, in the above method, it is difficult to acquire the deviation amount of the position with high precision. As to the position deviation amount for each position in the conveyance direction of the image, it is discrete information consisting of the distance of the formed pattern images. In a case where the distance between the pattern images is too long, the similarity with the sine function is reduced, thus it is difficult to acquire precise wavelength and amplitude. The shorter the distance between the pattern images, the higher the density of the pattern images, thus the similarity with the sine function is increased. Therefore, the analogical accuracy of the wavelength and amplitude of the sine function is increased. However, the minimum width of the pattern image and the distance between the pattern images are restricted since the irradiation spot diameter of the optical sensor is restricted, as described above.

### SUMMARY OF THE INVENTION

An image forming apparatus according to one embodiment of the present disclosure includes: an image bearing member configured to rotate; an image forming unit configured to form an image on the image bearing member; a detection unit configured to detect a test image formed on the image bearing member by the image forming unit; a controller configured to control a magnification of an image to be formed by the image forming unit based on a detection result of the test image by the detection unit, the test image having a configuration in which a plurality of pattern image sets are arranged in a direction that intersects a rotation direction of the image bearing member, the pattern image set including two or more pattern images arranged in the rotation direction at equal intervals, in the plurality of pattern image sets, each pattern image of the pattern image set being formed at a position different from each other in the rotation direction of the image bearing member.

Further features of the present invention will become apparent from the following description of exemplary embodiments (with reference to the attached drawings).

### BRIEF DESCRIPTION OF THE DRAWINGS

FIG. 1 is a configuration diagram of an image forming apparatus.

FIG. 2 is an explanatory view of a configuration of an image position detection unit.

FIG. 3 is an explanatory diagram of position detection of a test image.

FIG. 4 is a configuration diagram of a control system.

FIG. 5A, FIG. 5B, and FIG. 5C are explanatory diagrams of a method of detecting a position deviation amount.

FIG. 6 is an explanatory diagram of a method of predicting prediction data of the position deviation amount.

FIG. 7 is an explanatory diagram of prediction data of the position deviation amount in a case where resolution is low.

FIG. 8A and FIG. 8B are explanatory diagrams of restriction of resolution.

FIG. 9 is an exemplary diagram of a test image.

FIG. 10 is an explanatory view of a pattern image set.

FIG. 11 is an explanatory diagram of the prediction data of the position deviation amount.

FIG. 12 is an explanatory diagram of a detection image for detecting color misregistration.

### DESCRIPTION OF THE EMBODIMENTS

In the following, at least one embodiment of the present disclosure is described with reference to the drawings.

### <Image Forming Apparatus>

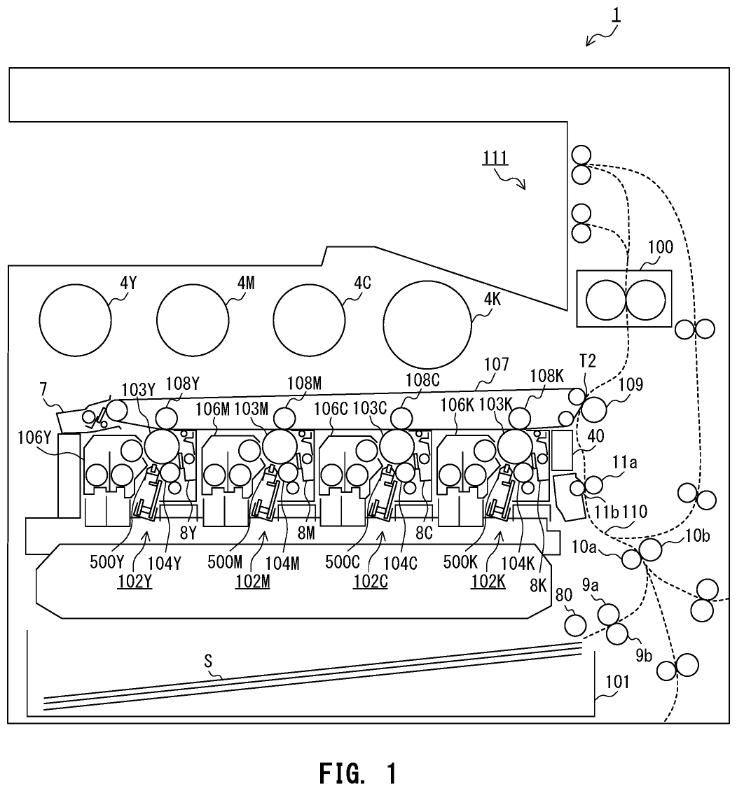

FIG. 1 is a configuration diagram of an image forming apparatus according to the first embodiment of the present disclosure. Although the image forming apparatus 1 of the present embodiment is a copying machine and MFP (Multi Function Printer) having a reading apparatus, the image forming apparatus may be a color printer without the reading apparatus. Further, the image forming apparatus 1 of the present embodiment is a color image forming apparatus of a so-called tandem system, however, the image forming apparatus 1 may be an image forming apparatus that forms a color image by a single photosensitive drum, or an image forming apparatus that forms a monochrome image.

An image forming apparatus 1 includes four image forming units 102y, 102m, 102c, and 102k. The image forming unit 102Y forms a yellow (Y) toner image. The image forming unit 102M forms a magenta (M) toner image. The image forming unit 102C forms a cyan (C) toner image. The image forming unit 102K forms a black (K) toner image. Each image forming units 102Y, 102M, 102C, and 102K has the same configuration. Subscripts Y, M, C, and K indicate toner color. In the following description, in a case where it is not necessary to distinguish the colors, the subscripts Y, M, C, and K at the end of the reference numerals are omitted.

The image forming unit 102 has a photosensitive drum 103, a charger 104, which serves as a charging unit, an exposure device 500, which serves as an exposure device, a developing unit 106, and a drum cleaner 8. The photosensitive drum 103 is a photosensitive member having a photosensitive layer on its surface. Each photosensitive drums 103Y, 103M, 103C, and 103K are spaced apart from each other. The charger 104 uniformly charges a surface of the photosensitive drum 103. The exposure device 500 has a Light Emitting Diode (LED) as a light source that emits light to expose a charged surface of the photosensitive drum 103. The surface of the photosensitive drum 103 is scanned, after charging, with laser light to thereby form an electrostatic latent image. In the image forming apparatus 1 of the present embodiment, the so-called “bottom surface exposure system” in which the photosensitive drum 103 is exposed from a lower part is employed. The developing unit 106 forms a toner image on a surface of the photosensitive drum 103 by developing the electrostatic latent image formed on the photosensitive with a toner of the corresponding color. Thus, the photosensitive drum 103 serves as an image bearing member which carries toner images (images).

The image forming apparatus 1 has an intermediate transfer belt 107, a primary transfer roller 108, a secondary transfer roller 109, and a fixing unit 100. The toner images are superimposed and transferred (primary transfer) onto the intermediate transfer belt 107 from each of the photosensitive drums 103Y, 103M, 103C, and 103K by primary transfer rollers 108Y, 108M, 108C, and 108K. The secondary transfer roller 109 forms a secondary transfer portion T2 which transfers (secondary transfer) the toner images on the intermediate transfer belt 107 onto the sheet S. Thus, the intermediate transfer belt 107 serves as an image bearing member which bears toner images (image). The fixing unit 100 fixes the toner image transferred on the sheet S.

The toner remains on the surface of the photosensitive drum 103 after the primary transfer. The toner remaining on the surface of the photosensitive drum 103 is removed by a drum cleaner 8, and is collected by a recovery toner container (not shown). The toner remains also on the surface of the intermediate transfer belt 107 after the secondary transfer. The toner remaining on the surface of the intermediate transfer belt 107 is removed by a belt cleaner 7 arranged near the intermediate transfer belt 107, and is collected by a recovery toner container (not shown).

The image forming apparatus 1 forms an image on the sheet S by operating as follows. As described above, the toner images are formed on the photosensitive drum 103 by each process of charging, exposing, and developing on the surface of the photosensitive drum 103. A toner image of yellow is formed on the photosensitive drum 103Y. A toner image of magenta is formed on the photosensitive drum 103M. A toner image of cyan is formed on the photosensitive drum 103C. A toner image of black is formed on the photosensitive drum 103K.

The toner image formed on each of the photosensitive drums 103 is transferred onto the intermediate transfer belt 107 by the corresponding primary transfer roller 108. A primary transfer bias is applied to the primary transfer roller 108 at the time of transferring. The intermediate transfer belt 107 is rotating. The toner image of each of the photosensitive drums 103 is transferred at a timing according to the rotation of the intermediate transfer belt 107, respectively. Thus, the toner images of the respective colors are superimposed on the intermediate transfer belt 107 to form the full-color toner image. The intermediate transfer belt 107 rotates to convey the toner image to the secondary transfer portion T2.

The toner image transferred onto the intermediate transfer belt 107 is transferred, at the secondary transfer portion T2, onto the sheet S by the secondary transfer roller 109. A secondary transfer bias is applied to the secondary transfer roller 109 at the time of transferring. The sheet S is fed to the secondary transfer portion T2 from a sheet feeding cassette 101 via a conveyance path 110.

The sheet S is stacked on the sheet feeding cassette 101, and is fed one by one to the conveyance path 110 in synchronization with the timing of image forming by each of the image forming units 102. In the conveyance path 110, a feeding roller 80, a separation roller pair 9a and 9b, a conveyance roller pair 10a and 10b, and a registration roller pair 11a and 11b are provided. The feeding roller 80 picks up the sheet S stacked on the sheet feeding cassette 101 by friction. The picked up sheet S is separated one by one at the separation roller pair 9a and 9b. The separated single sheet is conveyed to the registration roller pair 11a and 11b via the conveyance roller pair 10a and 10b. The registration roller pair 11a and 11b receives the sheet S in a stopped condition. The sheet S is conveyed, even after a tip of the same collided with the registration roller pair 11a and 11b which is in the stopped condition, by the conveyance roller pair 10a and 10b to form a roll to thereby correct skew. After correcting the skew, the registration roller pair 11a and 11b starts rotation, in synchronization with a timing at which the toner image on the intermediate transfer belt 107 is conveyed to the secondary transfer portion T2, to convey the sheet S to the secondary transfer portion T2.

The sheet onto which the toner image is transferred, at the secondary transfer portion T2, is conveyed to the fixing unit 100. The fixing unit 100 heats and pressurizes the sheet S to thereby fix the toner image on the sheet S. The sheet S on which the fixing process is performed by the fixing unit 100 is discharged, as printed matter, to the discharge portion 111. The image is formed on the sheet as described above.

The image forming apparatus 1 includes toner containers 4Y, 4M, 4C, and 4K. In each of the toner containers 4Y, 4M, 4C, and 4K, the toner of the corresponding color is contained. In the developing unit 106, the amount of toner decreases by performing image forming. As to the developing unit 106, in a case where the contained toner is decreased, the toner is supplied from the toner container 4 which contains the toner of the corresponding color via a pipe (not shown). That is, the image forming apparatus 1 of the present embodiment collects, as the remaining toner, a part of the excess toner into the recovery toner container (not shown) while supplying new toner from the toner container 4 into the developing unit 106.

### <Image Position Detection Unit>

The image forming apparatus 1 includes an image position detection unit 40 which is arranged near a portion of the intermediate transfer belt 107 that is positioned between the photosensitive drum 103K and the secondary transfer roller 109. The image forming units 102Y, 102M, 102C, and 102K form a test image, which is a detection image for detecting a forming position of an image of a corresponding color, onto the photosensitive drums 103Y, 103M, 103C, and 103K. The test image is a pattern image of a plurality of rectangles, for example. The test image on each of the photosensitive drums 103 is transferred onto the intermediate transfer belt 107. The image position detection unit 40 detects the test image of each color transferred onto the intermediate transfer belt 107. Based on a detection result of the test image by the image position detection unit 40, the position deviation amount with respect to a forming position of an ideal test image is detected.

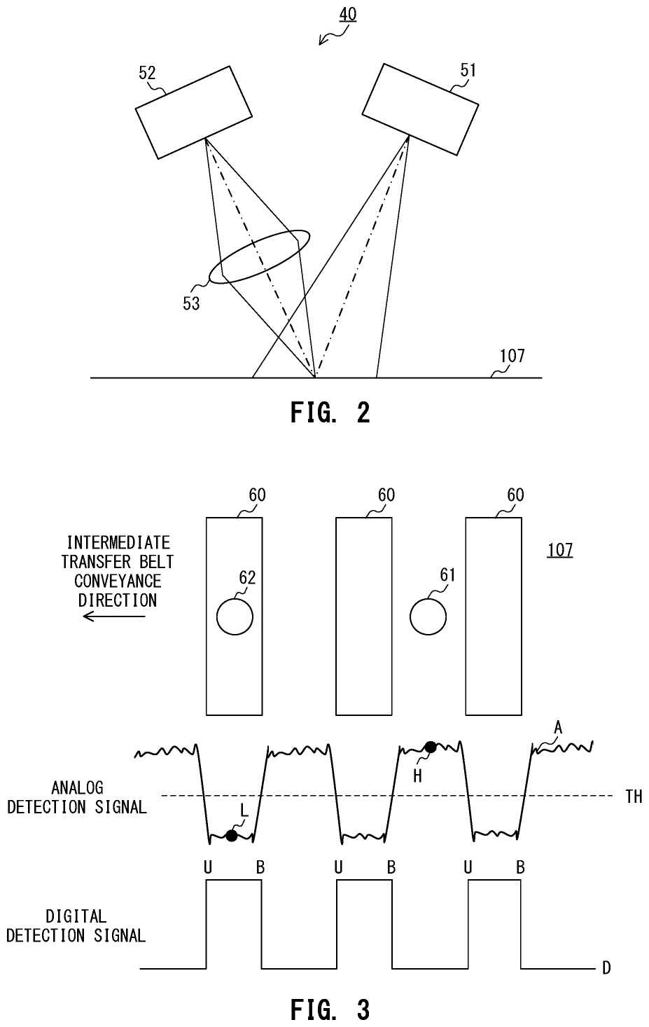

FIG. 2 is an explanatory view of a configuration of an image position detection unit 40. The image position detection unit 40 is an optical sensor which includes the light emitting unit 51, a light receiving unit 52, and a lens 53. The light emitting unit 51 irradiates light towards the intermediate transfer belt 107. The light receiving unit 52 receives regular reflection light of the light irradiated from the light emitting unit 51 towards the intermediate transfer belt 107. The light irradiated from the light emitting unit 51 is reflected by the intermediate transfer belt 107 which is arranged at an opposite position of the light emitting unit 51, or by the test image on the intermediate transfer belt 107. The reflected light reflected by the intermediate transfer belt 107 or the test image is focused by a lens 53 to enter the light receiving unit 52. The light receiving unit 52 outputs an analog detection signal which is a voltage (output value) according to the amount of the received reflected light. The reflection rate of the intermediate transfer belt 107 is higher than the reflection rate of the test image.

FIG. 3 is an explanatory diagram of position detection of the test image. The test image includes a pattern image 60 of a plurality of rectangles. In FIG. 3, irradiation spots 61 and 62 of the light from the light emitting unit 51 are illustrated. The irradiation spot 61 is an irradiation spot at the time of irradiating an area of the surface of the intermediate transfer belt 107 on which the pattern image 60 is not formed. An analog detection signal A acquired from the reflected light of the irradiation spot 61 has a relatively high voltage (H). The irradiation spot 62 is an irradiation spot at the time of irradiating the pattern image 60. An analog detection signal A acquired from the reflected light of the irradiation spot 62 has a relatively low voltage (L).

The analog detection signal A output from the image position detection unit 40 is converted into a digital detection signal D by binarization based on a predetermined threshold value TH. Based on a position of a leading edge U of the digital detection signal D and a position of a trailing edge B, a position of the pattern image 60 is detected. For example, a gravity center, which is the center of the position of the leading edge U and the position of the trailing edge B of the digital detection signal D, the leading edge U, or the position of the trailing edge B is detected as a position of the pattern image 60.

### <Control System>

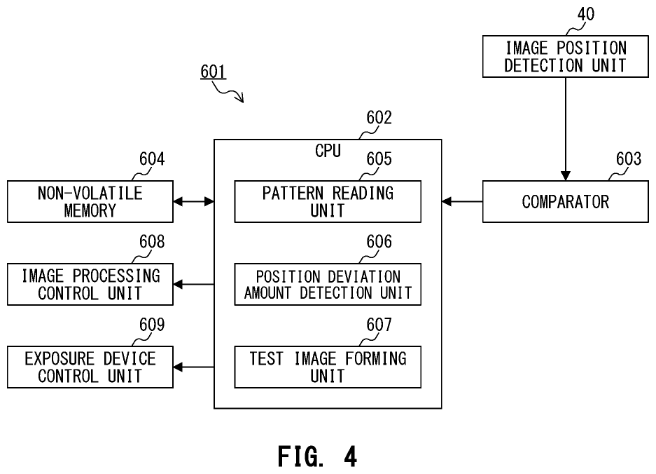

FIG. 4 is a configuration diagram of a control system which controls an operation of the image forming apparatus 1. The control system 601 includes a central processing unit 602 (CPU), a comparator 603, a non-volatile memory 604, an image processing control unit 608, and an exposure device control unit 609 and the like. The CPU 602 is a controller which controls the entire operation of the image forming apparatus 1 by executing a predetermined computer program. In the present embodiment, a process for correcting a position deviation of an image based on a reading result of a test image by the image position detection unit 40.

The image position detection unit 40 is connected to the comparator 603. The image position detection unit 40 inputs the analog detection signal A into the comparator 603. The comparator 603 binarizes the analog detection signal A to convert it into the digital detection signal D. The comparator 603 inputs the digital detection signal D into the CPU 602. In the present embodiment, as illustrated in FIG. 3, in a case where the analog detection signal A is more than a predetermined threshold value TH, the digital detection signal D is at a low level, and in a case where the analog detection signal A is less than the predetermined threshold value TH, the digital detection signal D is a high level.

That is, the comparator 603 outputs the digital detection signal D at the low level in a case where the image position detection unit 40 detects the reflected light from the intermediate transfer belt 107. Further, the comparator 603 outputs the digital detection signal D at the high level in a case where the image position detection unit 40 detects the reflected light from the pattern image 60. The threshold value TH is set so that the digital detection signal D as described above is output.

The CPU 602 serves as a pattern reading unit 605, a position deviation amount detection unit 606, and a test image forming unit 607. The pattern reading unit 605 detects timing at which the digital detection signal D changes from the low level to the high level (leading edge U) and timing at which the digital detection signal D changes from the high level to the low level (trailing edge B). Based on the position of the leading edge U and the position of the trailing edge B, the position deviation amount detection unit 606 detects the position of the pattern image 60. The position deviation amount detection unit 606 detects a position deviation amount, which is a difference between the position of the detected pattern image 60 and an ideal position of the pattern image. The position deviation amount of the present embodiment is a deviation amount of a forming position of the image in the conveyance direction (rotation direction) of the toner images by the intermediate transfer belt 107. The non-volatile memory 604 stores the position deviation amount detected by the position deviation amount detection unit 606. Alternatively, the non-volatile memory 604 may store data that indicates a detection position of the pattern image 60 in relation to a rotation angle of the photosensitive drum 103. The non-volatile memory 604 is a memory which is writable and readable.

The CPU 602 reads the position deviation amount from the non-volatile memory 604 at the time of starting, and corrects, based on the position deviation amount, the image forming condition under which image forming is performed according to a print job. By this correction, the forming position of the image according to the print job is corrected to be the ideal position. For example, the CPU 602 sets the read position deviation amount in the image processing control unit 608. The image processing control unit 608 performs image processing to the image data. The position deviation of the image to be formed on the sheet S is controlled since the image forming unit 102 forms the image based on the image data. For example, the image processing control unit 608 performs, the image processing to the image data so that a writing position of the image to be formed on the Sheet S is corrected. For example, the image processing control unit 608 performs the image processing to image data so that a magnification of the image to be formed on Sheet S is corrected. Further, the position deviation amount may be corrected by correcting light emitting timing of the exposure device 500 by the exposure device control unit 609.

The test image forming unit 607 stores the test image data at the time of forming the test image. In a case where the test image forming unit 607 forms the test image, the test image forming unit 607 transmits the test image data to the exposure device control unit 609. The exposure device control unit 609 forms the test image by exposing the photosensitive drum 103 based on the test image data.

### <Position Deviation Amount>

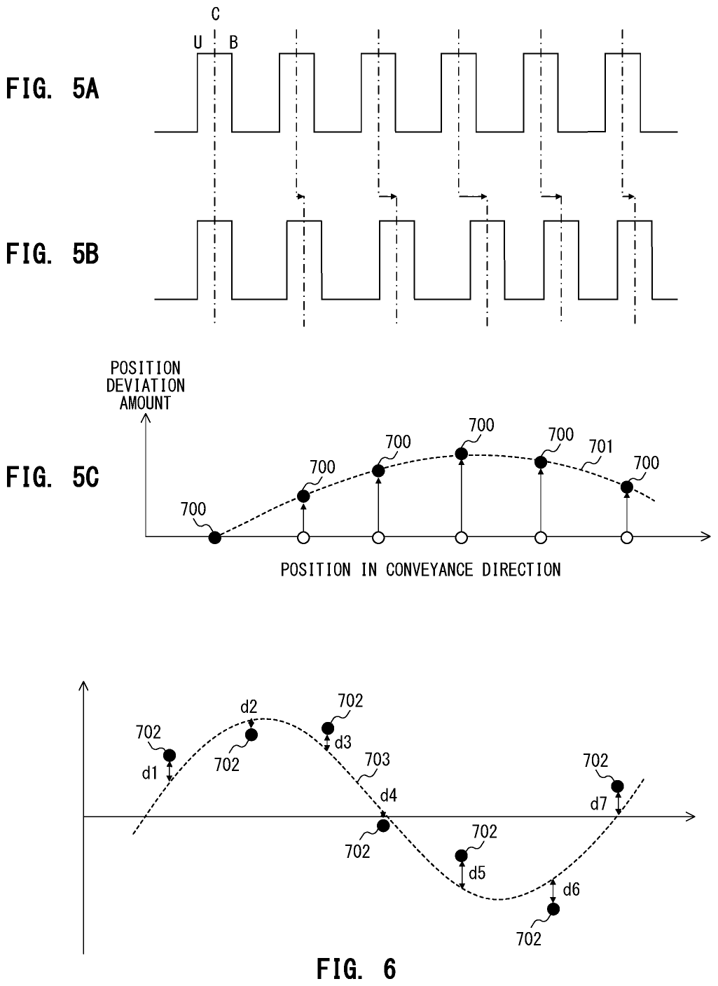

FIG. 5A to FIG. 5C are explanatory diagrams of a method of detecting a position deviation amount. FIG. 5A illustrates a digital detection signal D in a case where the test image (pattern image 60) is formed at the ideal position. In this case, a gravity center C, which is the center of the leading edge U and the trailing edge B of the digital detection signal D, is a position of the pattern image 60. FIG. 5B illustrates the digital detection signal D in a case where the test image (pattern image 60) is formed in a position deviated from the ideal position by disturbance. The disturbance is a change in a conveyance speed (rotation speed) of the intermediate transfer belt 107, or a change in a rotation speed of the photosensitive drum 103, for example.

FIG. 5C illustrates the relationship between the position of the intermediate transfer belt 107 in the conveyance direction and the position deviation amount. In FIG. 5C, the horizontal axis illustrates the position of the intermediate transfer belt 107 in the conveyance direction, and the vertical axis illustrates the position deviation amount of the pattern image 60 at each position in the conveyance direction. This graph represents the position deviation amount of the pattern image 60 in a case where the position deviation with respect to the ideal position occurs due to the disturbance. Each of the position deviation amounts 700 detected by the position deviation amount detection unit 606 is plotted at the ideal position of the pattern image 60. Since the pattern image 60 is formed at a predetermined interval, the position deviation amounts 700 are intermittent discrete values. By connecting the intermittent position deviation amounts 700, prediction data 701 of the position deviation amount is acquired.

FIG. 6 is an explanatory diagram of a method of predicting prediction data 701 of the position deviation amount. The position deviation amounts 702 (profile) are actual detection values, and are subject to measurement error. The prediction data 703 is predicted from the position deviation amounts 702 including the measurement error.

The magnitude of the position deviation amount changes in one cycle of the rotation member such as the photosensitive drum 103 and various rollers by which the intermediate transfer belt 107 is supported. This is due to the fact that the pattern image 60 is periodically deviated in the conveyance direction of the intermediate transfer belt 107, because of the form deflection of the rotation member and rotation speed unevenness of the rotation member, in one cycle of rotation of the rotation member.

The position deviation amount includes an amount of change similar to a sine function with a position (coordinate) of the intermediate transfer belt 107 in the conveyance direction as a variable. Therefore, the prediction data 703 is represented by two parameters, i.e., a wavelength and an amplitude, by applying the position deviation amount 702 to the similar sine function. Further, since the diameter of the rotation member is previously known, the wavelength of the sine function to be applied is clearly known.

The difference between the prediction data 703 and the position deviation amount 702 is expressed by differences d1-d7. The prediction data 703 is derived as the sine function that minimizes the following value of “Formula 1”. That is, the prediction data 703 is derived by performing fitting to the sine waveform having a predetermined wavelength previously determined by a least square method.

(d1)²+(d2)²+(d3)²+(d4)²+(d5)²+(d6)²+(d7)² (Formula 1)

### <Resolution>

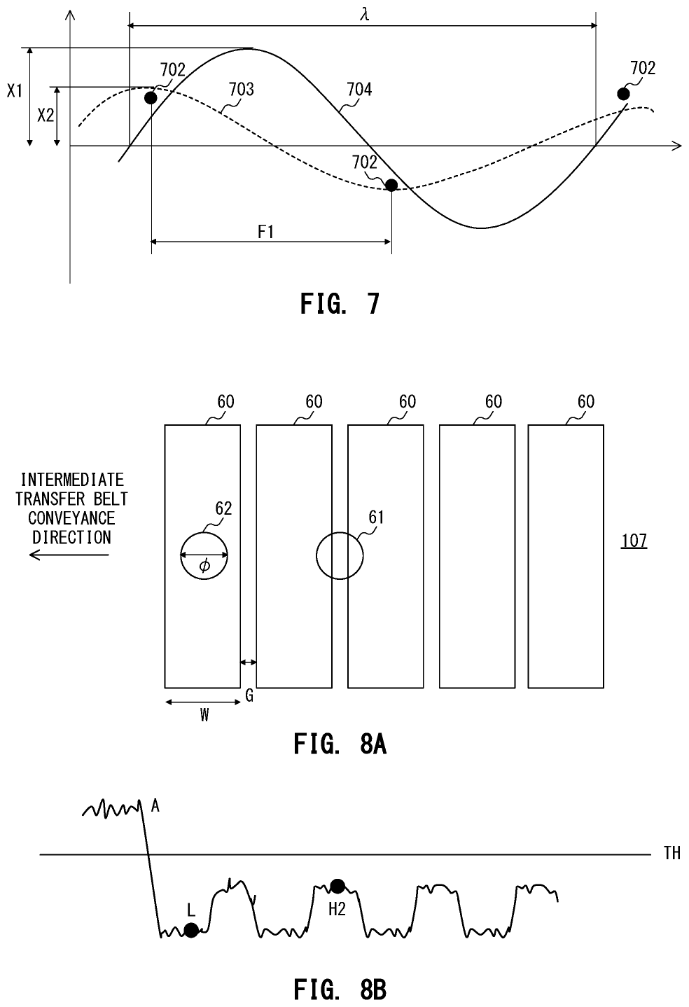

FIG. 7 is an explanatory diagram of prediction data of the position deviation amount in a case where resolution is low. The resolution is defined by the number of the detected position deviation amount. Therefore, an interval of the pattern image 60 influences the resolution. The narrower the interval of the pattern image 60, the higher the detected number of the position deviation amount, thus the resolution becomes high. The wider the interval of the pattern image 60, the lower the detected number of the position deviation amount, thus the resolution becomes low. In FIG. 7, the interval of the position deviation amount 702 is the resolution F1. The narrower the interval of the position deviation amount 702, the higher the resolution F1. The prediction data 703 is derived based on the position deviation amount 702 obtained by actually measuring the position of the pattern image 60. The ideal prediction data 704 is a wavelength λ.

In a case where the interval of the position deviation amount 702 is not smaller enough than the wavelength λ of the ideal prediction data 704 (i.e., in a case where the resolution F1 is low), the position deviation amount is predicted to be an amplitude X1 with the ideal prediction data 704. However, in practice, the position deviation amount will be predicted as amplitude X2 with the prediction data 703. In order to suppress the difference in the predicted value of such position deviation amount, the interval of the position deviation amount 702 should be less than half of the wavelength λ, of the ideal prediction data 704. That is, the interval of the position deviation amount 702 (interval of a pattern image) needs to be set equal to or less than half of one rotation length of the rotation member.

Among factors of the wavelength of the prediction data of the periodic position deviation, since rotation cycles of the photosensitive drum 103 and the like, are large enough, in many cases, the interval of the position deviation amount 702 may be narrow enough. That is, the resolution F1 can be higher. However, since the rotation cycles of a drive gear and the like which drive the photosensitive drum 103 are considerably short, the wavelength of the prediction data of the position deviation is considerably small. Therefore, the interval of the position deviation amounts 702 is also required to be small.

FIG. 8A and FIG. 8B are explanatory diagrams of the restriction of the resolution. FIG. 8A illustrates the relationship between the pattern image 60 and the irradiation spots 61 and 62. FIG. 8B illustrates an analog detection signal at the time of reading the pattern image 60 of FIG. 8A. The irradiation spot 61 is an irradiation spot at the time of irradiating, by the image position detection unit 40, an area on the intermediate transfer belt 107. The irradiation spot 62 is the irradiation spot at the time of irradiating, by the image position detection unit 40, the pattern image 60. The pattern image 60 is formed at an interval G.

The length of the ideal interval G is sufficiently more than an irradiation spot diameter φ of the irradiation spots 61 and 62, and is a length which allows the irradiation spots 61 and 62 to irradiate only the surface of the intermediate transfer belt 107. In this case, a sufficiently high voltage value is acquired such as the analog detection signal A in FIG. 3.

However, in a case where the interval G is less than the irradiation spot diameter gyp, the irradiation spot 61 spans the adjacent pattern images 60, as illustrated in FIG. 8A and FIG. 8B. In this case, since a light volume of a reflected light, which is received by the image position detection unit 40 from the intermediate transfer belt 107, is insufficient, a voltage value H2 of the analog detection signal A does not become sufficiently high. As described above, the analog detection signal A is compared with the threshold value TH and binarized to be converted into the digital detection signal D. In a case where the voltage value H2 of the analog detection signal A does not become sufficiently high and does not exceed the threshold value TH, it is difficult to perform accurate binarization.

Therefore, the interval G of the pattern image 60 should be more than the irradiation spot diameter φ. By making the interval G larger than the irradiation spot diameter φ, the irradiation spot 61 does not span the adjacent pattern images 60. Therefore, the image position detection unit 40 can receive sufficient light amount of the reflected light from the intermediate transfer belt 107, and can output the analog detection signal A having a sufficiently high voltage value.

Specifically, it is preferred that the irradiation spot diameter φ of the image position detection unit 40 is 1-2 mm, and it is preferable that the interval G of the adjacent pattern images 60 is set to more than or equal to 3 mm. Further, the width W of the pattern image 60 should be more than the irradiation spot diameter φ. Therefore, it is preferred that the width W of the pattern image 60 is set to more than or equal to 3 mm. Thus, it is necessary to extend the interval between the gravity centers of the adjacent pattern images 60 to be more than or equal to 6 mm, for example. This serves as a restriction that prevents the resolution from being sufficiently high.

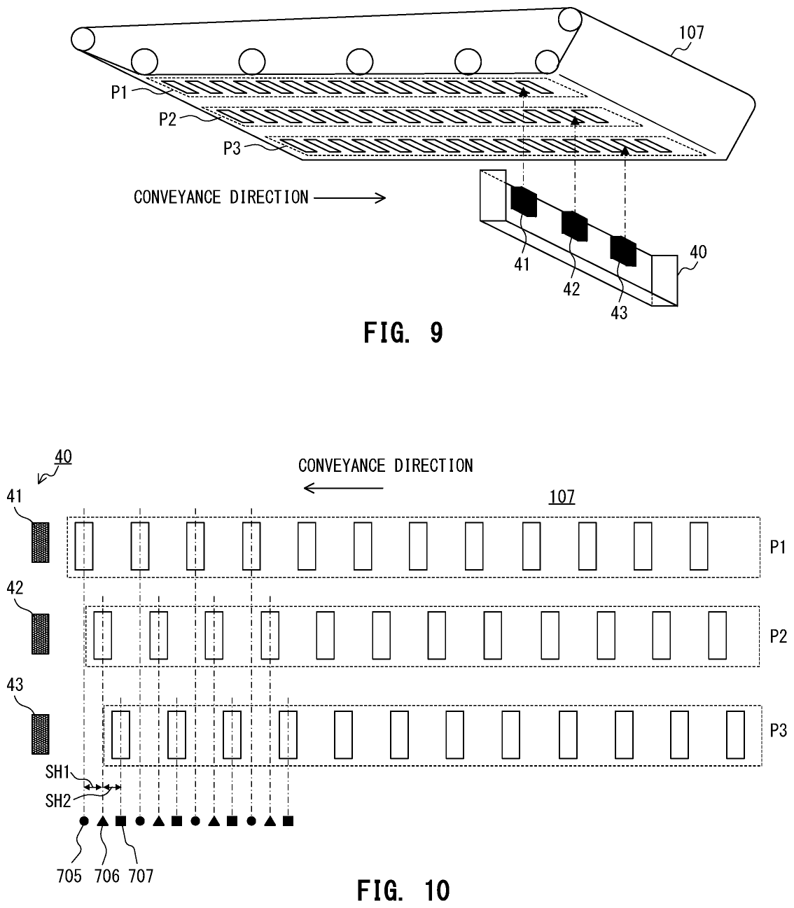

In the present embodiment, in order to increase the resolution, a test image, which is explained below, is formed on the intermediate transfer belt 107. FIG. 9 is an explanatory diagram of the test image formed on the intermediate transfer belt 107. The test image includes two or more pattern image sets P1, P2, and P3, each of which has a plurality of rectangle pattern images arranged at an equal interval in the conveyance direction (rotation direction) of the intermediate transfer belt 107. Two or more pattern image sets P1, P2, and P3 are arranged in a direction that intersects the conveyance direction of the intermediate transfer belt 107 (in this case, a direction orthogonal to the conveyance direction). Such test images are moved in the conveyance direction by rotation of the intermediate transfer belt 107.

The image position detection unit 40 includes two or more optical sensors. In the present embodiment, the image position detection unit 40 includes three optical sensors (first sensor 41, second sensor 42, and third sensor 43), the number of which is equal to the number of the pattern image set P1, P2, and P3. The first sensor 41 is used for detecting the pattern image set P1. The second sensor 42 is used for detecting the pattern image set P2. The third sensor 43 is used for detecting the pattern image set P3. In each pattern image set P1, P2, and P3, the interval between adjacent pattern images and the width of the pattern images are set according to the irradiation spot diameter. That is, the interval of the adjacent images and the width of the pattern image are set more than the irradiation spot diameter. Therefore, the first sensor 41, the second sensor 42, and the third sensor 43 can receive respectively sufficient amount of the reflected light.

FIG. 10 is an explanatory diagram of the pattern image set P1, P2, and P3 of the present embodiment. The pattern image set P2 is formed at a position displaced from the pattern image set P1 by a predetermined distance SH1 in the conveyance direction. The pattern image set P2 is offset from the pattern image set P1 in the conveyance direction. As to the position of the pattern image set P2 in the conveyance direction and the position of the pattern image set P1 in the conveyance direction, these positions may overlap when viewed from the direction orthogonal to the conveyance direction. The pattern image set P3 is formed at a position displaced from the pattern image set P2 by a predetermined distance SH2 in the conveyance direction. The pattern image set P3 is offset from the pattern image set P2 in the conveyance direction. Further, the pattern image set P3 is offset from the pattern image set P1 in the conveyance direction. As to the position of the pattern image set P3 in the conveyance direction and the position of the pattern image set P1 in the conveyance direction, these positions may overlap when viewed from the direction orthogonal to the conveyance direction. Further, as to the position of the pattern image set P3 in the conveyance direction and the position of the pattern image set P2 in the conveyance direction, these positions may overlap when viewed from the direction orthogonal to the conveyance direction. In FIG. 10, the sum of the distance SH1 and the distance SH2 is less than the interval of the pattern images of the pattern image set P1. Here, the distance SH1 (or SH2) is set to between 20% and 99% of the interval of the adjacent pattern images of the pattern image set P1. A position 705 is detected from the pattern images of the pattern image set P1. A position 706 is detected from the pattern images of the pattern image set P2. A position 707 is detected from the pattern images of the pattern image set P3. As to the pattern images included in each pattern image set P1, P2, and P3, the interval in the conveyance direction is more than the irradiation spot diameter and the size in the conveyance direction is more than the irradiation spot diameter.

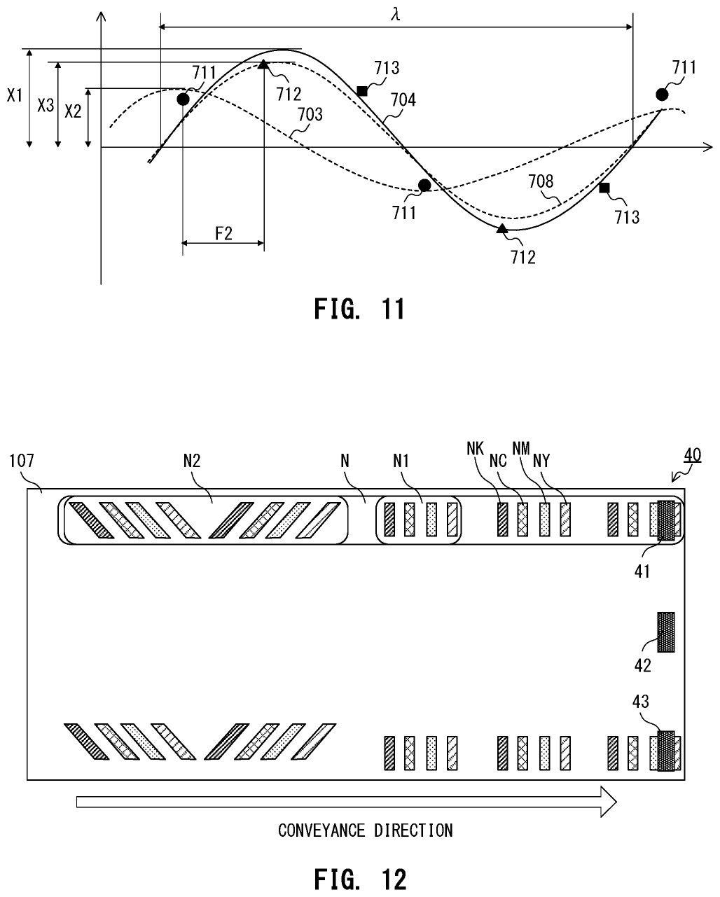

FIG. 11 is an explanatory diagram of prediction data of the position deviation amount detected from the pattern image sets P1, P2, and P3 of FIG. 10. A position deviation amount 711 is detected based on the position 705 detected from all the pattern images of the pattern image set P1. Based on the position deviation amount 711, the prediction data 703 having the position deviation amount of low resolution, which is the same as FIG. 7, is obtained. Position deviation amounts 711, 712, and 713 are detected based on the positions 705, 706, and 707 detected from all the pattern images of the pattern image sets P1, P2, and P3. Based on the position deviation amounts 711, 712, and 713, the prediction data 708 of the position deviation amount is obtained.

The Resolution F2 is represented by the adjacent intervals of all the pattern images of the pattern image sets P1, P2, and P3 (interval of position deviation amount). The interval of the position deviation amount becomes sufficiently narrow with respect to the wavelength λ of the ideal prediction data 704. That is, the interval of the position deviation amount becomes equal to or less than half of the wavelength λ. Therefore, the resolution F2 becomes sufficiently high and it becomes possible to predict the position deviation amount with high precision. The difference between an amplitude X1 of the ideal prediction data 704 and an actual amplitude X3 of the prediction data 708 of the position deviation amount becomes smaller as compared with the case of the amplitude X2 of the conventional prediction data 703.

As described above, it becomes possible to acquire high resolution by displacing the forming positions of the plurality of the pattern image set P1, P2, and P3 in the conveyance direction of the intermediate transfer belt 107 by a predetermined distance (distance SH1, SH2), respectively. Therefore, it becomes possible to generate the prediction data of the position deviation amount with high precision and predict the position deviation amount with high precision. For example, by setting both distances SH1 and SH2 as 2 mm, in a case where the pattern image interval of one pattern image set is 6 mm, it becomes possible to narrow the whole pattern image interval to 2 mm. Thus, the resolution becomes higher than the resolution in a case where the one pattern image is used, and the position deviation amount to be detected is increased, thus it is possible to generate the prediction data with high precision.

Any number of pattern image sets can be used as long as the number of pattern image sets is two or more. The distances SH1 and SH2, which are distances for displacing the forming position of the pattern image set, may be the same or different. As to the direction of displacing the forming position, it may be the same direction or an opposite direction with respect to the conveyance direction of the intermediate transfer belt 107. At any rate, the position should be displaced in the rotation direction so that the pattern images of each pattern image set do not have the same position in the direction that intersects the rotation direction (the conveyance direction) of the rotation member.

Here, a description is made for a method for correcting the position deviation amount at the time of actual image forming based on the prediction data of the position deviation amount. It is possible to detect the position deviation amount (amplitude) of the image correctly by using the prediction data. The wavelength of the prediction data is previously known, for example, it is a circumference length of a roller that supports the intermediate transfer belt 107.

In the image forming apparatus 1, an electrostatic latent image is formed on the surface of the photosensitive drum 103 by exposing a surface of the rotating photosensitive drum 103 by the exposure head (exposure device). The formation position of the electrostatic latent image is the formation position of the image on the surface of the photosensitive drum 103. Ideally, the exposure device 500 performs exposure with a fixed time interval to the photosensitive drum 103, which performs uniform rotation, to thereby form an image in an ideal position without position deviation. By using the test image of the present embodiment illustrated in FIG. 9 and FIG. 10, even in a case where the position deviation by disturbance occurs, the image is formed in an ideal position by performing correction based on the position deviation amount according to the prediction data. The image is formed by the image processing control unit 608 in a direction opposite to the direction in which the position deviation occurs according to the position deviation amount.

Specifically, the exposure device 500 does not irradiate the photosensitive drum at a constant exposure time interval. Rather, the exposure device 500 irradiates the photosensitive drum, based on the position deviation amount (amplitude) and the wavelength acquired from the prediction data, so that the waveform of the prediction data is in the opposite phase. Thereby the position deviation of the image of the photosensitive drum 103 in the rotation direction is suppressed. Further, the periodic position deviation of the image of the intermediate transfer belt 107 in the conveyance direction (rotation direction) is suppressed. By suppressing the periodic position deviation, the geometric characteristics, such as distortion of the form of the image formed in the printed matter, are corrected.

In addition, the color of the test image is monochrome. The position deviation is detected for each color of yellow, magenta, cyanogen, and black to generate the prediction data. Therefore, the correction of the above position deviation will be performed for each color. Further, the image data which represents the test image is stored in the test image forming unit 607 for each color. When performing the correction of the position deviation, the CPU 602 reads the image data of the corresponding color from the test image forming unit 607 to control, based on the image data, the exposure device control unit 609 to perform an exposure control of the exposure device 500 of the corresponding image forming unit 102. In this manner, a monochrome test image is formed on the intermediate transfer belt 107.

The rotation direction of the photosensitive drum 103 matches with the conveyance direction of the intermediate transfer belt 107. This direction intersects a direction in which light is scanned when exposing is performed by the exposure device 500. The direction in which light is scanned is a main scanning direction, and a direction that intersects the main scanning direction is a sub-scanning direction. Therefore, the position deviation to be controlled in the test image of FIG. 9 and FIG. 10 is the position deviation in the sub-scanning direction. The position deviation of the image of each of the photosensitive drums 103Y, 103M, 103C, and 103K is not superimposed accurately on the intermediate transfer belt 107, thus the position deviation causes so-called “color misregistration”. Therefore, in order to suppress color misregistration, it is necessary to correct both the position deviation in the main scanning direction and the position deviation in the sub-scanning direction.

### <Color Misregistration Correction>

FIG. 12 is an explanatory diagram of detection images for detecting color misregistration which is used in correcting the color misregistration. The detection images N are formed on the intermediate transfer belt 107 as illustrated in FIG. 12. The detection images N are formed at both ends of the intermediate transfer belt 107 in the main scanning direction at an interval of a predetermined width and interval such that each of the pattern image NY of yellow, the pattern image NM of magenta, the pattern image NC of cyan, and the pattern image NK of black does not overlap each other. Here, the main scanning direction means a direction that intersects with the conveyance direction (rotation direction) of the intermediate transfer belt 107. The detection images N are transferred from each of the photosensitive drums 103Y-103K to the intermediate transfer belt 107, as illustrated in FIG. 12. Each of the detection images N is constituted by combining the pattern images NY, NM, NC, and NK, and the detection image N contains a pattern image N1 for correcting the color misregistration in the sub-scanning direction and a pattern image N2 for correcting the color misregistration in the main scanning direction.

As described above, the image position detection unit 40 includes the first sensor 41, the second sensor 42, and the third sensor 43, and is formed at a position where the corresponding detection image N can be detected. In the example of FIG. 12, the image position detection unit 40 reads the detection images N by two sensors, i.e., the first sensor 41 and the third sensor 43, corresponding to each of the detection images N formed at both ends in the main scanning direction of the intermediate transfer belt 107. The first sensor 41 and the third sensor 43 irradiate the intermediate transfer belt 107 with light to output an analog signal which represents a detection value according to the amount of reflected light. The amount of reflected light of the intermediate transfer belt 107 at a portion where none of the detection images N is formed differs from that of the intermediate transfer belt 107 at a background portion where none of the detection images N is not formed. Therefore, as to the analog signal output from the light receiving unit 52, a detection value detected at a portion where the detection image N is formed differs from that detected at a background portion.

In a case where the color misregistration correction is performed, the image forming apparatus 1 detects, with the position at which the pattern image NY of yellow is formed being a reference position, a relative position with respect to the reference position for each of the pattern images NM, NC, and NK of other colors. The image forming apparatus 1 detects the relative deviation amount according to the relative position of each pattern image NY, NM, NC, and NK, and control the color misregistration correction based on this deviation amount so that the deviation does not occur between the toner images of each color in the case of image forming. For example, the color misregistration is corrected by correcting image forming conditions such as light emitting timing of the exposure device 500.

As described above, the image forming apparatus 1 of the present embodiment can acquire sufficient resolution for predicting the position deviation amount. Therefore, in the image forming apparatus 1, it is possible to predict a periodic change of the position of the image in the sub-scanning direction (conveyance direction of the intermediate transfer belt 107) with high accuracy. Therefore, the periodic change in the position of the image can be corrected with high accuracy. Thus, the periodic position deviation of the images formed by single color is corrected, and the quality of the printed matter is improved. Further, by performing the color misregistration correction after performing the correction of the periodic position deviation, it is possible to perform the color misregistration correction with high precision.

Although the configuration in which the position deviation amount is detected based on the test image formed on the intermediate transfer belt 107 is explained in the above description, it is also possible to detect the position deviation amount based on a test image formed on the photosensitive drum 103. In this case, the image position detection unit 40 is formed corresponding to each of the photosensitive drums 103. The image position detection unit 40 is provided between the developing unit 106 and the intermediate transfer belt 107 to detect a toner image developed by the developing unit 106. As in the test image illustrated in FIG. 10, the toner image formed on the photosensitive drum 103 has a configuration in which a plurality of rectangular pattern images (pattern image set) are arranged in a direction which intersects the rotation direction of the photosensitive drum 103. Each pattern image set is formed at a different position from each other in the rotating direction of the photosensitive drum 103.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-083124, filed May 20, 2022, which is hereby incorporated by reference herein in its entirety.

What is claimed is:

1. An image forming apparatus comprising:
an image bearing member configured to rotate;
an image forming unit configured to form an image on the image bearing member;
a detection unit configured to detect a test image formed on the image bearing member by the image forming unit;
a controller configured to control a magnification of an image to be formed by the image forming unit based on a detection result of the test image by the detection unit,
the test image having a configuration in which a plurality of pattern image sets are arranged in a direction that intersects a rotation direction of the image bearing member, the pattern image set including two or more pattern images arranged in the rotation direction at equal intervals,
in the plurality of pattern image sets, each pattern image of the pattern image set being formed at a position different from each other in the rotation direction of the image bearing member.

2. The image forming apparatus according to claim 1,
wherein the plurality of pattern image sets are arranged such that each of the pattern images is formed at a position displaced from each other by a predetermined distance in the rotation direction such that each of the pattern images is not located at same position in the direction that intersects the rotation direction.

3. The image forming apparatus according to claim 2,
wherein the image bearing member is configured to rotate by a rotation member, and the interval between adjacent pattern images in the rotation direction is equal to or less than half of one rotation length of the rotation member.

4. The image forming apparatus according to claim 3,
wherein the sensor is an optical sensor, and is configured to irradiate light toward the image bearing member,
wherein the interval between adjacent pattern images in the rotation direction is equal to or more than an irradiation spot diameter of light irradiated from the optical sensor, and
wherein a size of the pattern image in the rotation direction is more than the irradiation spot diameter.

5. The image forming apparatus according to claim 3, wherein the pattern image has a rectangular shape.

6. The image forming apparatus according to claim 1,
wherein the image forming unit is configured to be capable of forming images of a plurality of colors, and
wherein the test image is composed of a single color.

7. The image forming apparatus according to claim 6,
wherein the controller is configured to:
store image data which represents the test image for each color; and
control the image forming unit to form the test image of a corresponding color based on the image data.

8. The image forming apparatus according to claim 7,
wherein the image forming unit comprises a plurality of photosensitive member corresponding to colors, and is configured to form an image of corresponding color on each photosensitive member, and
wherein the image bearing member is an intermediate transfer belt onto which the image is transferred from the plurality of photosensitive member.

9. The image forming apparatus according to claim 1,
wherein the image forming unit is configured to form an image on the image bearing member based on a predetermined image forming condition, and
wherein the controller is configured to:
detect a position deviation amount from the position of the test image and an ideal position of the test image; and
correct the image forming condition based on the position deviation amount predicted based on prediction data which is generated based on the position deviation amount.
